(19) United States
(12) Patent Application Publication
(10) Pub. No.: US 2023/0393850 A1
(43) Pub. Date: Dec. 7, 2023

(54) BREATHING OPERAND WINDOWS TO EXPLOIT BYPASSING IN GRAPHICS PROCESSING UNITS

(71) Applicant: The Regents of the University of California, Oakland, CA (US)

(72) Inventors: Hodjat Asghari Esfeden, Riverside, CA (US); Nael Abu-Ghazaleh, Riverside, CA (US)

(73) Assignee: The Regents of the University of California, Oakland, CA (US)

(21) Appl. No.: 18/032,157

(22) PCT Filed: Oct. 15, 2021
(86) PCT No.: PCT/US21/55283

§ 371 Date: Apr. 14, 2023

Related U.S. Application Data
(60) Provisional application No. 63/092,489, filed on Oct. 15, 2020.

(51) Int. Cl. G06F 9/30; G06F 9/38

(52) U.S. Cl. CPC G06F 9/30123; G06F 9/3877

(57) ABSTRACT

A register file architecture of a processing unit (e.g., a Graphics Processing Unit (GPU)) includes a processing pipeline and operand collector organization architecturally configured to support bypassing register file accesses and instead pass values directly between instructions within the same instruction window. The processing unit includes, or utilizes, a register file (RF). The processing pipeline and operand collector organization is architecturally configured to utilize temporal locality of register accesses from the register file (RF) to improve both the access latency and power consumption of the register file.

### TECHNICAL FIELD

Various embodiments described herein generally relate to computational platforms, and in particular, an improved Register File (RF) architecture (e.g., of a GPU processing pipeline and operand collector organization) architecturally configured to utilize temporal locality of register accesses to the register file (RF) to bypass register file accesses and facilitate improvements to the access latency and/or power consumption of the RF.

### INTRODUCTION

Graphics Processing Units (GPUs) have emerged as an important computational platform for data-intensive applications in a plethora of application domains. They are commonly integrated in computing platforms at all scales, from mobile devices and embedded systems, to high-performance enterprise-level cloud servers. Graphics Processing Units use a massively multi-threaded architecture that exploits fine-grained switching between executing groups of threads to hide the latency of data accesses.

Graphics Processing Units have continued to increase in energy usage, so it is an important constraint on the maximum computational capabilities that can be achieved. Peak performance of any system is essentially limited by the amount of power it can draw and the amount of heat it can dissipate. Consequently, performance per watt of a GPU design translates directly into peak performance of a system that uses that design.

In order to support fast context switching between threads, GPUs invest in large Register Files (RFs) to allow each thread to maintain its context (in hardware) at all times. The Register File (RF) is a critical structure in GPUs, and its organization or architecture substantially affects the overall performance and the energy efficiency of a GPU. By way of example, from 2008-2018 the size of the Register File has increased across generations of NVIDIA GPUs from Tesla (2008) to Volta (2018) almost tenfold to 20 MB, making it an even more critical and important component.

Instructions normally get/read/obtain their input data (called source operands) from the Register File data structure. To retrieve the value for each source operand, current GPUs require one separate read access to the register file which puts unnecessary pressure on register file ports.

It would be helpful to be able to provide an improved RF architecture (e.g., an improved RF in a GPU).

It would be helpful to be able to provide an RF architecture that facilitates improvements to the access latency and/or power consumption of the register file.

### BRIEF DESCRIPTION OF THE DRAWINGS

FIG. 1 is a flow chart showing an example method 100 for providing or improving a register file architecture of a Graphics Processing Unit (GPU).

FIG. 2A shows an example embodiment of a GPU architecture 200, Breathing Operand Windows (BOW), architecturally configured to overcome redundant reads only—also referred to herein as BOW-R. BOCX is Bypassing Operand Collector assigned to Warp X.

FIG. 2B shows a baseline operand collector unit (left) compared to a wider Bypassing Operand Collector (BOC) unit 250 with forwarding logic support (right).

FIG. 2C shows another example embodiment of a GPU architecture 300 providing a processing pipeline and operand collector organization, referred to herein as BOW-WR, architecturally configured to overcome redundant writes and reads.

FIG. 3 is an example of a Code snippet illustrating bypassing operations (along with compiler support) in architectures (e.g., BOW-R and BOW-WR) such as described herein.

FIG. 4 is a bar graph showing Instructions Per Cycle (IPC) improvement achieved by BOW-WR compared to the baseline BOW-R, using different instruction windows.

FIG. 5 is a bar graph showing Register File (RF) dynamic energy normalized to the baseline for BOW-WR.

### DESCRIPTION

Frequent accesses to the register file structure during kernel execution incur a sizeable overhead in GPU power consumption, and introduce delays as accesses are serialized when port conflicts occur. For example, port conflicts (in register file banks as well as operand collector units that collect the register operands) cause delays in issuing instructions as register values are read in preparation for execution.

We have observed that there is a high degree of temporal locality in accesses to the registers: within short instruction windows, the same registers are often accessed repeatedly. Registers are often accessed multiple times in a short window of consecutive instructions, as values are incrementally computed or updated and subsequently used.

Example embodiments and implementations described herein involve a new GPU architecture (technique), Breathing Operand Windows (BOW), that exploits the temporal locality of the register accesses to improve both the access latency and power consumption of the register file. The BOW architecture can be implemented, for example, in the form of or utilizing a GPU processing pipeline and operand collector organization (e.g., as described herein).

Opportunities to reduce register accesses are (or can be) characterized as a function of the size of the instruction window considered, and the recurring reads and updates of register operands (e.g., in GPU computations) can be established/identified and utilized in providing an enhanced GPU processing pipeline and operand collector organization that supports bypassing register file accesses and instead passes values directly between instructions within the same instruction window. As a result, a substantial fraction of register read and register write accesses can bypass the register file by being forwarded directly from one instruction to the next. This operand bypassing reduces dynamic access energy by eliminating register accesses (both reads and writes) from the RF, and improves overall performance by reducing port contention and other access delays to the register file banks. In other embodiments and implementations, operand bypassing is deployed by eliminating register accesses only for (only bypassing) register reads. Compiler optimizations can be utilized to help guide the writeback destination of operands depending on whether they will be reused to further reduce the write traffic.

We have observed that registers are often accessed multiple times in a short window of instructions, as values are incrementally computed or updated and subsequently used. As a result, a substantial fraction of register read and register write accesses can bypass the register file and instead operands are forwarded directly from one instruction to the next. This operand bypassing reduces dynamic access energy by eliminating register accesses (both reads and writes, in some implementations) from the RF, and improves overall performance by reducing port contention and other access delays to the register file banks. In the GPU execution model, a kernel is the unit of work issued typically from the CPU (or directly from another kernel if dynamic parallelism is supported). A kernel is a GPU application function, decomposed by the programmer compiler into a grid of blocks mapped each to a portion of the computation applied to a corresponding portion of a typically large data in parallel. Specifically, the kernel is decomposed into Thread Blocks (TBs, also Cooperative Thread Arrays or CTAs), with each being assigned to process a portion of the data. These TBs are then mapped to Streaming Multiprocessors (SMs) for execution. The threads executing on an SM are then grouped together into groups of threads (warps in NVIDIA terminology, or wavefronts in AMD terminology) for the purposes of scheduling their issuance and execution. Warp instructions are selected and issued for execution by warp schedulers in the SM (typically 2 or 4 schedulers, depending on the GPU generation). Warps that are assigned to the same warp scheduler compete for the issue bandwidth of that scheduler.

All the threads in a warp execute instructions in a lock-step manner (Single Instruction Multiple Thread, or SIMT model). Most GPU instructions use registers as their source and/or destination operands. Therefore, an instruction will access the Register File (RF) to load the source operands for all of its threads, and will write back any destination operand after the execution to the RF. The RF in each SM is typically organized into multiple single-ported register banks so as to support a large memory bandwidth without the cost and complexity of a large multi-ported structure. A banked design allows multiple concurrent operations, provided that they target different banks. When multiple operations target registers in the same bank, a bank conflict occurs and the operations are serialized, affecting overall performance.

BOW re-architects the GPU execution pipeline to take advantage of operand bypassing opportunities. Specifically, in the baseline design we consider operands reused within an instruction window: a key to increasing bypassing opportunities is to select the instruction window size carefully to capture register temporal reuse opportunities while maintaining acceptable overheads for the forwarding. To facilitate bypassing, an operand collector is dedicated to each warp so that it can hold the set of active registers for that warp in a simple high performance buffering structure dedicated for each warp. Whenever a register operand is needed by an instruction, BOW first checks if the operand is already buffered so it can use it directly without the need to load it from the RF banks. If the operand is not present in the operand collector unit, a read request will be generated to the RF, which is sent to the arbitrator unit. In the baseline BOW, after an instruction finishes execution, the computed result is written back to both the operand collector unit as well as the register file (i.e., a write through configuration). This organization supports reuse of operand reads and avoids the need for an additional pathway to enable writing back values from the operand collector to the RF when they slide out of the window. Based on our experiments and observations, BOW with a window size of 3 instructions reduces the physical register read accesses by 59% across all of our benchmarks. In example embodiments/implementations, window size is fixed and is defined in the design. The window size is determined/selected in consideration of overheads and can be selected from a range of window sizes such as, for example, 2-7 instructions. However, for implementations where every write is still written to the RF, write bypassing is not supported.

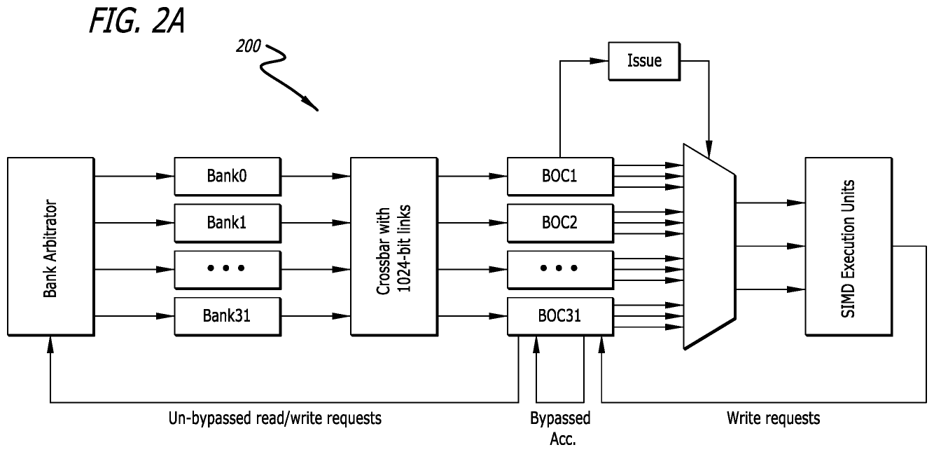

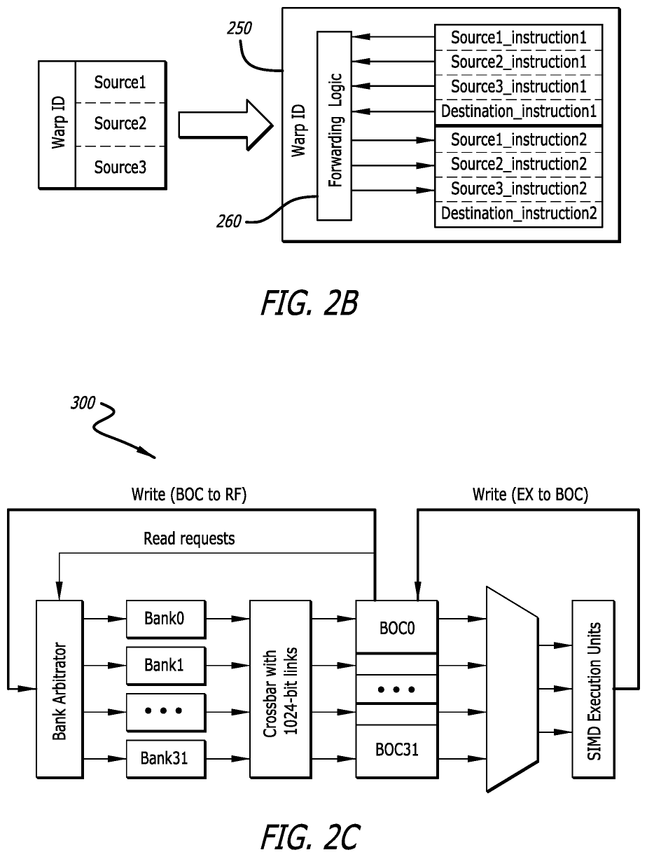

In order to be able to capitalize on the opportunities for write bypassing, and referring to FIG. 2C (which shows a GPU architecture providing a processing pipeline and operand collector organization architecturally configured to overcome redundant writes and reads), we introduce BOW-WR, an improved design that uses a write-back philosophy to overcome the redundant writes present in BOW. Specifically, the improved design writes any updated register values back to the operand collector only. When an instruction slides outside of the current window its updated register value is written back to the RF only if it has not been updated again by a subsequent instruction in the window (in which case that first write has been bypassed since the update was transient). As described, BOW-WR shields the RF from some of the write traffic, but does not capture all write bypassing opportunities, and preserves some redundant and inefficient write behavior. Consider the following two cases:
(1) Unnecessary operand collector (OC) writes: When a value will no longer be reused, writing it to the OC first, and then to the RF causes a redundant update. Instead such value is written directly to the RF;
(2) Unnecessary RF writes: When an updated register value is no longer live (i.e., it will not be read again before it is updated), it will be written back to the RF unnecessarily when the instruction slides out of the active window. In this case, not writing the value back to the RF is preferable.

Capturing either of these opportunities directly in the architecture depends on the subsequent behavior of the program. Thus, to exploit the opportunity to eliminate these redundant write backs in BOW-WR, the compiler is configured and tasked to perform liveness analysis and classify each destination register to one of these three groups: those that will be written back only to the register file banks (to handle case 1 above); operands that will be written back only to the operand collectors (to handle case 2); and finally operands that first need to reside in operand collector and then due to their longer lifetime need to be written back to the register file banks for later use (this was the default behavior of BOW-WR before the compiler hints). These compiler hints are passed to the architecture by encoding the writeback policy for each instruction using two bits in the instruction. This compiler optimization not only substantially minimizes the amount of write accesses to the register file and fixes the redundant write-back issue, but also reduces the effective size of the register file as a significant portion of register operands are transient, not needed outside the instruction windows (52% with a window size of 3): thusly, allocating registers in the RF is avoided altogether for such values.

With respect to implementation, a primary cost incurred by the baseline BOW (and BOW-WR) is the cost of increasing the number of operand collectors (so that there is one dedicated per warp) as well as the size of each operand collector to enable it to hold the register values active in a window. With respect to the size of each operand collector (OC), the baseline design adds additional entries to each operand collector to hold the operands within the active window (4 registers per instruction in the window). In the baseline design, this adds around 36 KB of temporary storage for a window size of 3 across all OCs, which is significant (but still only around 14% of the RF size of modern GPUs). In order to reduce this overhead, we observe experimentally that this worst case sizing substantially exceeds the mean effective occupancy of the bypassing buffers. Thus, we provision BOW-WR with smaller buffering structures. However, since the available buffering can be exceeded under the worst case scenarios, we have redesigned (architecturally configured) the OCs to allow eviction of values when necessary. Additionally, the window size is restricted to the predetermined fixed window size and instructions are not bypassed beyond the window size even if there is sufficient buffer space in the buffering structure. The reason for this choice is to facilitate the compiler analysis and tag the writeback target in BOW-WR correctly in the compiler taking into account the available buffer size. Without this simplifying assumption, an entry which is tagged by the compiler for no writeback to the RF may need to be saved if it is evicted before all of its reuses happen. Accordingly, we are able to reduce the storage size by 50% with a performance reduction of less than 2%. Considering other overheads (such as modified interconnect), BOW requires an area increase of 0.17% of total on-chip area.

Breathing Operand Windows

In this section, we overview the design of BOW-WR and also introduce and discuss a number of compiler and microarchitectural optimizations to improve reuse opportunities, as well as to reduce overheads. BOW includes (or consists of) three primary components: (1) Bypassing Operand Collector (BOC) augmented with storage for active register operands to enable bypassing among instructions. Each BOC can be dedicated to a single warp, which simplifies buffering space management since each buffer is accessed only by a single warp. The sizing of the BOC is determined by the instruction window size within which bypassing is possible; (2) Modified operand collector logic that considers the available register operands and bypasses register reads for available operands (whereas baseline operand collectors fetch all operands from the RF), e.g., logic embedded into BOCs that can “forward” values from one instruction to another; and (3) Modified write-back pathways and logic which enable directing values produced by the execution units or loaded from memory to the BOCs (to enable future data forwarding from one instruction to another) as well as to the register file (for further uses out of the current active window) in the baseline design. The writeback logic is further optimized with compiler-assisted hints in the improved BOW-WR.

A. BOW Architecture Overview

FIGS. 2A and 2B provide a diagrammatic overview of BOW architectures described herein and highlight the primary changes and additions to the architecture. The design centers around new operand collector unit additions, called the Bypassing Operand Collectors (BOC) 250 (in relation to example embodiments herein), that allow the GPU to bypass RF accesses. Each BOC is assigned to a single warp (BOC0-BOC31) in FIG. 2A. While the operand collectors in the baseline architecture have three entries to hold the data of the source operands of a single instruction (FIG. 2B, left), BOW widens the operand collectors to enable the storage of source and destination register values for the usage of subsequent instructions (FIG. 2B, right). In addition, the forwarding logic 260 in the BOC 250 is architecturally configured to check whether the requested operands are already in the BOC so will be sent to the next instruction. Similar to the baseline architecture, and to avoid making the interconnection network more complicated, BOCs can (each) have a single port to receive operands coming from the register file banks. However, the forwarding logic within the BOCs is architecturally configured to allow forwarding multiple operands available in the forwarding buffers when an instruction is issued. In the baseline design, we conservatively reserve four entries per each instruction in the BOC to match the maximum possible number of operands which is three source operands plus one destination. Such conservative sizing is rarely needed, which allows the BOC to be provisioned with substantially smaller storage.

Instructions for the same warp are scheduled to the assigned BOC in program order as the instruction window slides through the instructions. When instruction x at the end of the window is inserted into the BOC 250, the Forwarding Logic 260 checks if any of the required operands by instruction x is already available in the current window, then the oldest instruction (first instruction in the current window) with its operands are evicted from the window to make room for the next instruction, which will become available when the window moves. It is important to note that the instruction window is sliding; every time an operand is used by an instruction it remains active for window size instructions after that. If it is accessed again in this window, its presence in the BOC is extended in what we refer to as the Extended Instruction Window. In case of branch divergence, the BOC waits until the next instruction is determined. Instructions from different BOCs are issued to the execution units in a round-robin manner. As soon as all the source operands for an instruction are ready (which potentially have been forwarded directly within the active window and without sending read requests to the register file), the instruction is dispatched and sent to the execution unit. When the execution of an instruction ends, its computed result is written back to the assigned BOC (to be used later by next instructions in the window). In the baseline BOW, this value is also written back to the register file (for potential later uses, if any, by an instruction out of the current window). It is noted here that only the pathway from execution units to the BOCs has been added in our design thusfar, as the pathway from execution units to the register file is already established in the baseline architecture. While such a write-through policy minimizes the complexity, it suffers substantial redundant write backs (to the BOCs as well as register file)—an inefficiency addressed in BOW-WR.

Please note that two dependent instructions where there is a RAW (read after write) or WAW (write after write) dependency between them can never be among the ready to issue instructions within the same BOC. The scoreboard logic checks for these kinds of dependencies prior to issuance of instructions to the operand collection stage (this is actually done when a warp scheduler schedules an instruction). Having an instruction in one of the BOCs means that it has already passed the dependency checks and its register operands exist either in the BOC or the register file. For independent instructions, there is no delay for bypassing: both can start executing, and even finish out-of-order.

BOW-WR: Compiler-Guided Writeback

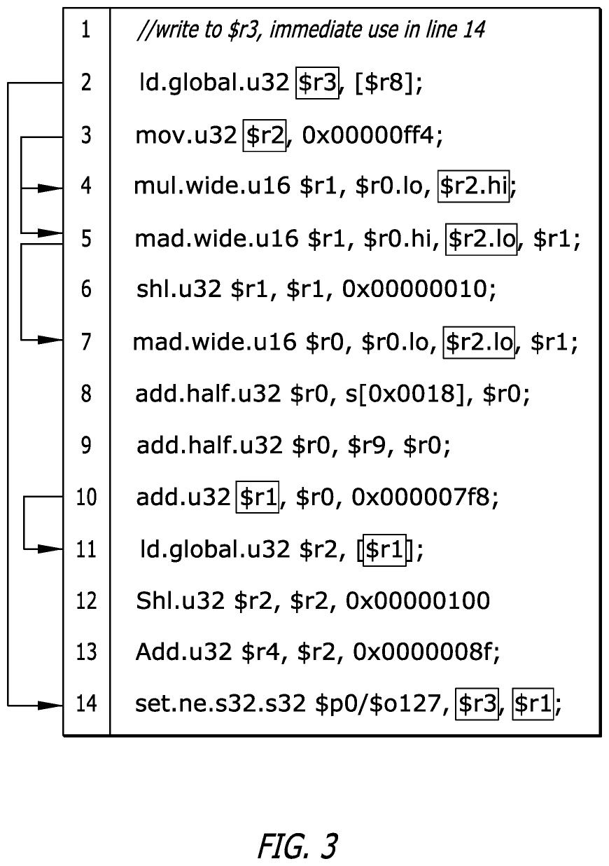

BOW exploits read bypassing opportunities, but is not able to bypass any of the possible write operations as every computed value is written not only to the RF, but also to the BOC, following a write-through policy for simplicity. However, write bypassing opportunities are important: often a value is updated repeatedly within a single window. For example, consider $r1 being updated by the instructions in lines 4, 5, and 6 of FIG. 3; it only needs to be updated in the RF after the final write.

BOW-WR approaches bypassing using a write-back philosophy to enable write bypassing. In the simplest case, it writes the computed results always to the BOC to provide opportunities for both read and write bypassing. When an updated operand slides out of the current active window, the forwarding logic checks if it has been updated again by a subsequent instruction within the active window. If so, the write operation will be bypassed, allowing the consolidation of multiple writes happening within the same instruction window. In our prior example (FIG. 3), when instructions 4 and 5 slide out of the active window, their updated $r1 is discarded since in each case $r1 is updated again within the window. When instruction 6 slides out, the value is written back (since neither instruction 7 nor 8 update $r1). The primary cost of BOW-WR (write-back instead of write-through) is that a new pathway needs to be established from BOCs to the RF.

Although using a write-back philosophy significantly reduces the amount of redundant writes to the register file (Table I—below), it is not able to bypass all such write operations; in many instances, as an operand slides out of an active window, it is written back from the BOC to the register file while it is not actually going to be used again by later instructions (the operand is no longer live). Another source of inefficiency arises since computed operands are always written back to the BOC; if these operands are not needed again in the active window, they could have been written directly to the RF, eliminating the write to the BOC.

Embodiments herein can be considered to be or provide a (file register) microarchitecture of a GPU: microarchitectures of the several stages, namely (or inclusive of), the RF and the Execution Units (which is the next stage after the RF). In either of the situations in the preceding paragraph, the microarchitecture does not have sufficient information to identify the optimal target of the writeback, since it depends on the future behavior of the program which is generally not visible at the point where the writeback decisions are made, leading to the redundant writes. In example embodiments/implementations, to facilitate elimination of these redundant writes, the compiler is utilized to analyze the program and guide with the selection of the write back target. The program is the kernel (function that runs on the device) that is running on the GPU. By way of example, the compiler (e.g., NVidia Cuda Compiler (NVCC) in the case of NVIDIA GPUs) is configured and tasked to perform liveness analysis and dependency checks to determine if the output data from an instruction should be written back only to the register file bank (when it will not be used again in the instruction window), only to the bypassing operand collector (for transient values that will be consumed completely in the window and no longer live after it), or both (which is the default behavior without the compiler hint). A liveness analysis checks the lifetime of values (a value is live if a subsequent instruction is going to use it. On the other hand, it is dead after the point where it is read for the last time). When we avoid writing values back to the RF, we reduce the pressure on the RF and avoid the cost of unnecessary writes for operands that are still in use. Similarly, when we write data to the BOC which is not going to be used, we pay the extra cost of this write only to later have to save the value again to the RF. An interesting opportunity also occurs in that transient values that are produced and consumed completely within a window no longer need to be allocated a register in the RF. We have discovered that many operands are transient, leading to a substantial opportunity to reduce the effective RF size. Compiler-guided optimizations yield the benefits of avoiding unnecessary writes and minimizing energy usage. Table I shows the needed number of write accesses to the RF for the code in FIG. 3 in the different versions of BOW (note that BOW write-through is identical to the unmodified GPU).

TABLE I
Number of write operations to the register
file for code snippet shown in FIG. 3.

# of write accesses to the Register file in:

| Destination | BOW | BOW | BOW-WR |
|---|---|---|---|
| Operand | (write-through) | (write-back) | (compiler Opt.) |
| $r0 | 3 | 1 | 0 |
| $r1 | 4 | 2 | 1 |
| $r2 | 2 | 1 | 0 |
| $r3 | 1 | 1 | 1 |
| Total | 10 | 5 | 2 |

Highlighted Results:

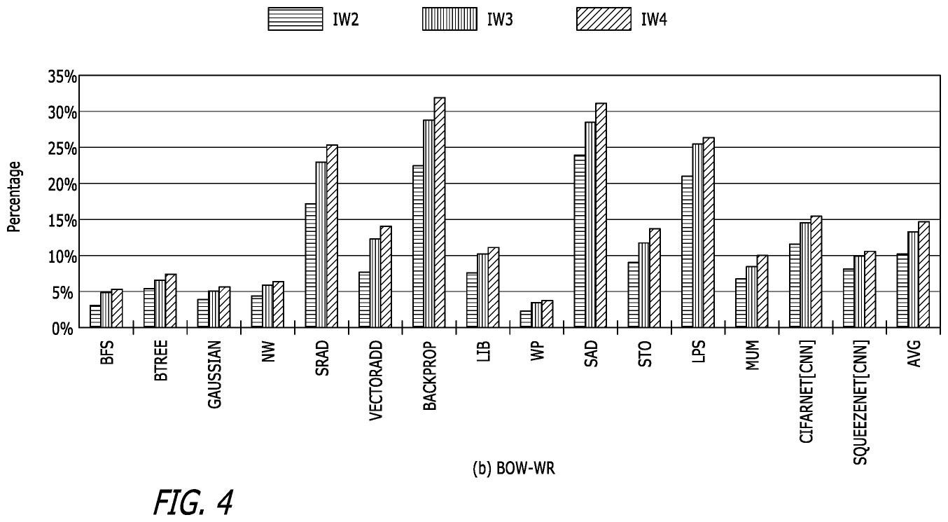

Performance: FIG. 4 displays the normalized Instructions Per Cycle (IPC) improvement achieved by BOW-WR compared to the baseline, using different instruction windows. As a result of bypassing substantial amount of read and write operations, port contention decreases (on both register file banks as well as BOCs), leading to better performance. Notably, we observe IPC improvement across all benchmarks. On average, with a window of three instructions, BOW-WR can improve the IPC by 13%.

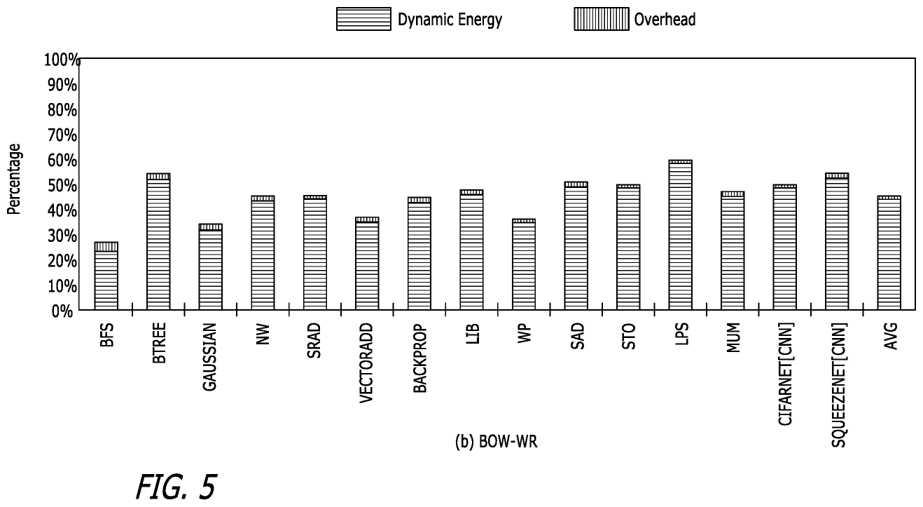

RF Energy: FIG. 5 shows the dynamic energy of the RF normalized to the baseline GPU for BOW-WR. The small segments on top of each bar represent the overheads of the structures added by the aforementioned design. Dynamic energy savings in FIG. 5 are due to the reduced number of accesses to the register file as BOW-WR shields the RF from unnecessary read and write operations. Specifically, BOW-WR with a window size of 3 instructions reduces RF dynamic energy consumption by 55%, after considering 1.8% increase in overhead.

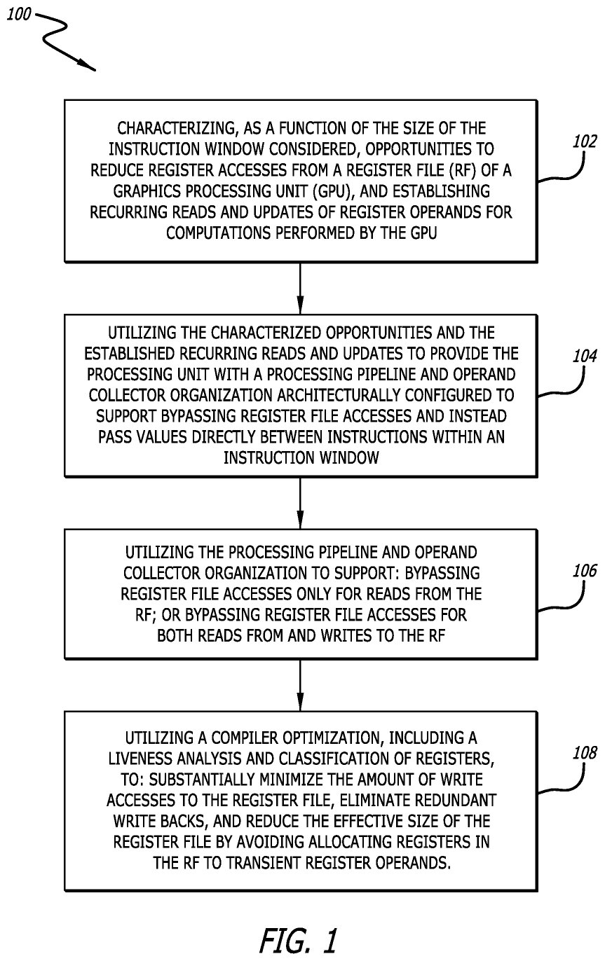

Thus, and referring to FIG. 1, in an example embodiment, a method 100 for providing or improving a register file architecture of a processing unit (e.g., of a Graphics Processing Unit (GPU)) includes: at 102, characterizing (or identifying), as a function of the size of the instruction window considered, opportunities to reduce register accesses from a register file (RF) of a processing unit, and establishing (or identifying) recurring reads and updates of register operands for (a group of) computations performed by the processing unit; and, at 104, utilizing the characterized opportunities and the established recurring reads and updates to provide the processing unit with a processing pipeline and operand collector organization architecturally configured to support bypassing register file accesses and instead pass values directly between instructions within the same instruction window. For example, the processing unit is (or includes) a Graphics Processing Unit (GPU). In example (e.g., baseline) embodiments/implementations, the processing pipeline and operand collector organization is architecturally configured to support bypassing register file accesses only for reads from the RF. In other example embodiments/implementations, the processing pipeline and operand collector organization is architecturally configured to support bypassing register file accesses for both reads from and writes to the RF. Accordingly, in example embodiments/implementations, the method 100 further includes, at 106, utilizing the processing pipeline and operand collector organization to support: bypassing register file accesses only for reads from the RF; or bypassing register file accesses for both reads from and writes to the RF. In other example embodiments/implementations, the method 100 further includes, at 108, utilizing a compiler optimization, including a liveness analysis and classification of (destination) registers, to: substantially minimize the amount of write accesses to the register file, eliminate redundant write backs, and reduce the effective size of the register file by avoiding allocating registers in the RF to transient register operands.

To conclude this section, we have observed that register values are reused repeatedly in close proximity in GPU workloads. We herein describe technologies and methodologies that uniquely exploit this behavior to forward data directly among nearby instructions, thereby shielding the power-hungry and port-limited register file from many accesses (59% of accesses with an instruction window size of 3). The BOW-WR design described herein has the capability to bypass both read and write operands, and leverages compiler hints to optimally select write-back operand target. Further with regard to compiler hints, their encoding into bits of the instruction happens at compile time. Generally, a program is first compiled with a compiler. (The input to a compiler is a program, say kernel.cu, and the output of a compilation process is an executable binary that can be executed on the GPU). During the compilation process, the compiler is tasked to do the liveness analysis, and the information (i.e., compiler hints) defining where a value will be written to (BOC, register file, or both) is injected or encoded into the executable binary. BOW-WR reduces RF dynamic energy consumption by 55%, while at the same time increasing performance by 11%, with a modest overhead of 12 KB of additional storage (4% of the RF size).

While example embodiments have been described herein, it should be apparent, however, that various modifications, alterations and adaptations to those embodiments may occur to persons skilled in the art with the attainment of some or all of the advantages of the subject matter described herein. The disclosed embodiments are therefore intended to include all such modifications, alterations and adaptations without departing from the scope and spirit of the technologies and methodologies as described herein.

What is claimed is:

1. A register file architecture of a Graphics Processing Unit (GPU) comprising:
a processing pipeline having a Register File (RF) and an operand collector organization architecturally configured to support bypassing register file accesses and instead pass values directly between instructions within an instruction window.

2. The register file architecture of claim 1, wherein the processing pipeline and operand collector organization is architecturally configured to utilize temporal locality of register accesses from the RF to improve access latency and power consumption of the RF.

3. The register file architecture of claim 1, wherein the processing pipeline and operand collector organization is architecturally configured as a function of a size of an instruction window considered, to reduce register accesses from the RF.

4. The register file architecture of claim 1, wherein the processing pipeline and operand collector organization is architecturally configured utilizing buffered values of recurring reads and updates of register operands for computations performed by the GPU to eliminate redundant accesses from the register file.

5. The register file architecture of claim 1, wherein the processing pipeline and operand collector organization is architecturally configured to eliminate redundant write backs.

6. The register file architecture of claim 1, wherein the operand collector is further architecturally configured to write any updated register values back to the operand collector only.

7. The register file architecture of claim 1, wherein the processing pipeline and operand collector organization is architecturally configured in consideration of operands reused within an instruction window to support bypassing register file accesses and instead pass values directly between instructions within the instruction window.

8. The register file architecture of claim 1, wherein the processing pipeline and operand collector organization is architecturally configured to utilize high temporal operand reuse to bypass having to read and write reused operands to the register file.

9. The register file architecture of claim 1, wherein the processing pipeline includes a Bypassing Operand Collector (BOC) augmented with storage for active register operands to enable bypassing among instructions as well as logic to control the bypassing.

10. The register file architecture of claim 1, wherein the processing pipeline and operand collector organization includes operand collector logic architecturally configured to consider the available register operands and bypass register reads for available operands.

11. The register file architecture of claim 1, wherein the processing pipeline and operand collector organization includes execution units, Bypassing Operand Collectors (BOCs) and write-back pathways and logic architecturally configured to enable directing values produced by the execution units or loaded from memory to the BOCs to enable future data forwarding from one instruction to another.

12. The register file architecture of claim 1, wherein the instruction window has an instruction window size comprised of a plurality of instructions.

13. The register file architecture of claim 1, wherein the processing pipeline and operand collector organization is architecturally configured to utilize compiler hints encoded in received instructions to control where a value will be written to.

14. A method for providing or improving a register file architecture of a Graphics Processing Unit (GPU), the method comprising:
characterizing, as a function of a size of an instruction window considered, opportunities to reduce register accesses from a register file (RF) of a Graphics Processing Unit (GPU), and establishing recurring reads and updates of register operands for computations performed by the GPU; and
utilizing the characterized opportunities and the established recurring reads and updates to provide the processing unit with a processing pipeline and operand collector organization architecturally configured to support bypassing register file accesses and instead pass values directly between instructions within an instruction window.

15. The method for providing or improving a register file architecture of claim 14, wherein the processing pipeline and operand collector organization is architecturally configured to support bypassing register file accesses only for reads from the RF.

16. The method for providing or improving a register file architecture of claim 14, wherein the processing pipeline and operand collector organization are architecturally configured to support bypassing register file accesses for both reads from and writes to the RF.

17. The method for providing or improving a register file architecture of claim 14, further comprising:
utilizing a compiler optimization, including a liveness analysis and classification of registers, to:
substantially minimize the amount of write accesses to the register file, eliminate redundant write backs, and
reduce the effective size of the register file by avoiding allocating registers in the RF to transient register operands.

18. A Graphics Processing Unit (GPU) comprising:
a microarchitecture inclusive of a register file (RF) and associated logic having a processing pipeline and operand collector organization architecturally configured to support bypassing register file accesses and instead pass values directly between instructions within an instruction window.
